(19) United States
(12) Patent Application Publication
(10) Pub. No.: US 2010/0027878 A1
(43) Pub. Date: Feb. 4, 2010

(54) CONTENT DETECTION OF AN IMAGE COMPRISING PIXELS

(75) Inventors: Sudip Saha, Bangalore (IN); Anil Yekkala, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/442,725

(22) PCT Filed: Sep. 24, 2007
(86) PCT No.: PCT/IB2007/053858

§ 371 Date: Mar. 25, 2009

(30) Foreign Application Priority Data
Sep. 28, 2006 (EP) 06121441.7
Mar. 6, 2007 (EP) 07103544.8

(51) Int. Cl. G06K 9/00

(52) U.S. Cl. 382/162

(57) ABSTRACT

Methods for image content detection check (15) color values of pixels via color conditions and check (18) pixels via edge conditions and check (22) functions of numbers of edge conditioned pixels and numbers of color conditioned pixels via ratio conditions and generate (23), in response to ratio condition detection results, block content detection signals. These methods perform well for green content (greeneries like grass, leaves of trees, bushes) and blue content (water like river water, sea water) and are used for content based classifications and automatic selections of images. The methods may be repeated (12) for different blocks of an image, and may then check (32), for a block, neighboring blocks and may check (33-1) functions of numbers of neighboring blocks via block neighbor conditions and may check (33-2) functions of numbers of edge conditioned pixels and numbers of color conditioned pixels via further ratio conditions and may generate (34), in response to block neighbor condition detection results and further ratio condition detection results, image content detection signals.

### FIELD OF THE INVENTION

The invention relates to a method for detecting a content of at least a part of an image comprising pixels, to a computer program product, to a medium, to a processor, to a device and to a system.

Examples of such a device and of such a system are consumer products, such as video players, video recorders, personal computers, mobile phones and other hand helds, and non-consumer products. Examples of such a content are contents of a specific type and contents of a desired type.

### BACKGROUND OF THE INVENTION

US 2006/0072829 A1 discloses a method and an apparatus for representing and searching for color images. According to this method and this apparatus, a region of an image is selected, and for that region one or more colors are selected as representative colors. For a region having two or more representative colors, for each representative color at least two parameters related to the color distribution are calculated, to derive descriptors for the image region.

This method and this apparatus use color histograms for showing color distributions and are therefore relatively complex.

### SUMMARY OF THE INVENTION

It is an object of the invention, inter alia, to provide a relatively simple method.

Further objects of the invention are, inter alia, to provide a relatively simple computer program product, a relatively simple medium, a relatively simple processor, a relatively simple device and a relatively simple system.

A method for detecting a content of at least a part of an image comprising pixels, each pixel being defined by at least one color value, is defined by comprising:
a first step of, for each pixel of a group of pixels, detecting whether the at least one color value fulfils at least one color condition defined by at least one threshold value,
a second step of, for each pixel from the group of pixels that has fulfilled the at least one color condition, detecting whether this pixel fulfils at least one edge condition,
a third step of detecting whether a function of a number of pixels that have fulfilled the at least one edge condition and a number of pixels that have fulfilled the at least one color condition fulfils at least one ratio condition, and
a fourth step of, in response to a ratio condition detection result, generating a block content detection signal.

The at least one color value for example comprises twenty-four bits, eight bits for indicating a red value, eight further bits for indicating a blue value and eight yet further bits for indicating a green value. Alternatively, the at least one color value for example comprises three separate values in the form of a red value, a blue value and a green value, each one of these values being defined by for example eight or sixteen or twenty-four bits. Other and/or further values and other and/or further numbers of bits are not to be excluded. Usually, a first group of color conditions and a second group of threshold values may be used etc.

The group of pixels forms for example a block within the image, or forms a selection from all pixels that together form the image. Such a selection may comprise neighboring pixels and non-neighboring pixels. For example, the group of pixels may comprise every second or third pixel of a set of rows of the mage and may comprise every second or third pixel of a set of columns of the image.

The first step detects, for each pixel of the group of pixels, whether the color value of the pixel fulfils the color condition defined by one or more threshold values. Thereto, in practice, for example the red, blue and green values are compared with each other and/or with functions of red, blue and green values and/or with predefined values.

The second step detects, for each pixel from the group of pixels that has fulfilled the color condition, whether this pixel fulfils the edge condition. In practice, a pixel has a fixed location in the image, and this fixed location may be an edge of the image or the block or the group of pixels or a region (fulfillment) or not (non-fulfillment).

The third step detects whether the function of I) the number of pixels that have fulfilled the edge condition and II) the number of pixels that have fulfilled the color condition fulfils the ratio condition. Thereto, in practice, for example a ratio of the number of pixels that have fulfilled the edge condition and the number of pixels that have fulfilled the color condition is compared with a ratio value.

The fourth step generates, in response to the ratio condition detection result, the block content detection signal. This block content detection signal may be a simple yes/no signal or a more sophisticated signal that for example further indicates a degree of fulfillment.

As a result, a simple method for image content detection has been created. Especially, but not exclusively, for a non-artificial content from nature, the method has proven to perform well. For example a green content such as greeneries like grass, leaves of a tree, and bushes, and for example a blue content such as water like river water and sea water are detected well. The method is for example used for a content based classification and/or an automatic selection of an image and/or an outdoor image detection and/or a grass detection for a 3-D image to estimate a depth of one or more pixels and/or a detection of a background useful for an MPEG encoder.

An embodiment of the method is defined by claim 2. Preferably, but not exclusively, in response to the color condition detection result, the color condition signal is generated, and/or in response to the edge condition detection result, the edge condition signal is generated, and/or in response to the ratio condition detection result, the ratio condition signal is generated.

An embodiment of the method is defined by claim 3. Preferably, but not exclusively, the method as defined by claim 1 is repeatedly performed per block or per group of pixels, to generate several block content signals for several blocks or several groups of pixels. This way, more parts or the image are detected, and more information about the image is produced.

An embodiment of the method is defined by claim 4. Preferably, but not exclusively, the sixth, seventh, eighth and ninth step are added to the first to fifth steps, for further increasing the amount of information about the image.

The sixth step detects, for the block for which the confirming block content detection signal has been generated, whether there are neighboring blocks for which confirming block content detection signals have been generated. Thereto, in practice, for example block content detection signals of neighboring blocks are compared with each other.

The seventh step detects the function of the number of neighboring blocks for which confirming block content detection signals have been generated fulfils the block neighbor condition. Thereto, in practice, for example this number is counted and compared with a neighbor value.

The eighth step detects, for the block and the neighboring blocks for which confirming block content detection signals have been generated, whether the function of III) the number of pixels that have fulfilled the edge condition and IV) the number of pixels that have fulfilled the color condition fulfils the further ratio condition. Thereto, in practice, for example a further ratio of the number of pixels that have fulfilled the edge condition and the number of pixels that have fulfilled the color condition is compared with a further ratio value.

The ninth step generates, in response to the block neighbor condition detection result and the further ratio condition detection result, the image content detection signal. This image content detection signal may be a simple yes/no signal or a more sophisticated signal that for example further indicates a degree of fulfillment.

An embodiment of the method is defined by claim 5. Preferably, but not exclusively, the tenth and eleventh step are added to improve a performance of the first and second steps.

The tenth step detects, for each pixel from the group of pixels that has fulfilled the color condition, whether there are neighboring pixels that have fulfilled the color condition. Thereto, in practice, for example for the pixel that has fulfilled the color condition, one or two or three further pixels left from and/or right from and/or above and/or below this pixel are checked for fulfilling the color condition or not.

The eleventh step detects whether the function of the number of neighboring pixels that have fulfilled the color condition fulfils the pixel neighbor condition. Thereto, in practice, for example this number is counted and compared with a further neighbor value. As a result, the second step can be performed in an improved and more efficient way for each pixel from the group of pixels that has fulfilled the at least one color condition as well as that has neighboring pixels for which the function of the number of these neighboring pixels has fulfilled the pixel neighbor condition.

A computer program product for performing the steps of the method is defined by claim 6. A medium for storing and comprising the computer program product is defined by claim 7. A processor for performing the steps of the method is defined by claim 8. Such a processor for example comprises first and second and third detection means and generation means. A device for detecting a content of at least a part of an image comprising pixels is defined by claim 9. Such a device for example comprises first and second and third detectors and a generator. A system comprises the device as claimed in claim 9 and further comprises a memory for storing color values of pixels of images. Alternatively, the memory may form part of the device.

Embodiments of the computer program product and of the medium and of the processor and of the device and of the system correspond with the embodiments of the method.

An insight might be, inter alia, that, for a relatively simple content detection of a group of pixels, firstly one or more conditions per pixel are to be checked and secondly one or more conditions per group of pixels are to be checked. A basic idea might be, inter alia, that for a content detection of a group of pixels, a color condition per pixel is to be checked and an edge condition per pixel that has fulfilled the color condition is to be checked and a ratio condition per group of pixels is to be checked.

A problem, inter alia, to provide a relatively simple method for content detection of at least a part of an image, is solved. A further advantage might be, inter alia, that content based classifications and automatic selections of images and outdoor image detections show an improved success rate.

These and other aspects of the invention are apparent from and will be elucidated with reference to the embodiments described hereinafter.

### BRIEF DESCRIPTION OF THE DRAWINGS

In the drawings:

FIG. 1 shows a flow chart of a method,

FIG. 2 shows a block diagram of a system comprising a processor, and

FIG. 3 shows a block diagram of a system comprising a device.

### DETAILED DESCRIPTION

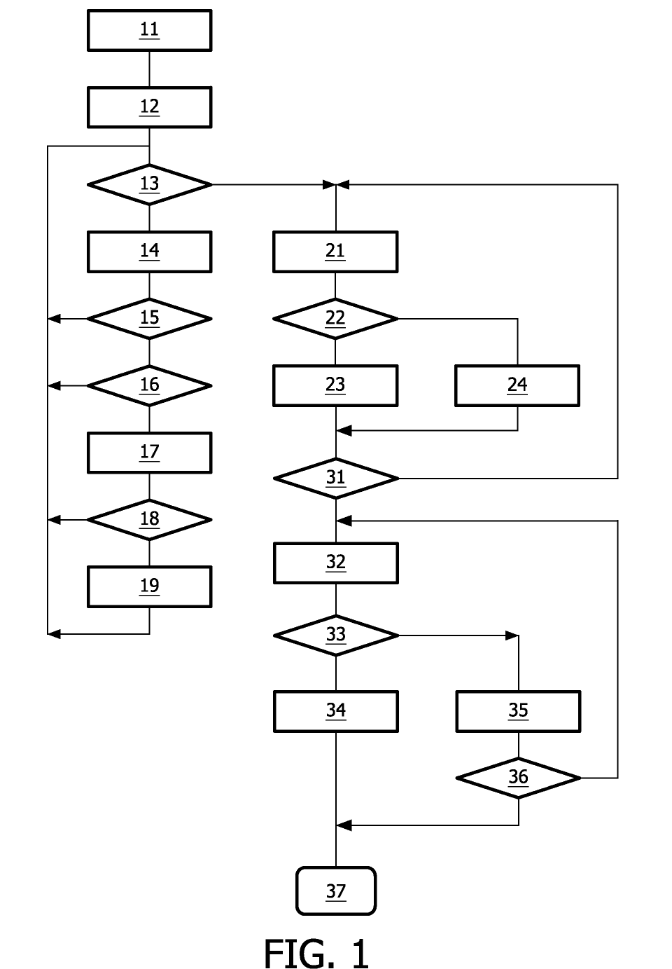

In the FIG. 1, the following blocks have the following meaning:

Block 11: Start. Convert image information into a color value per pixel and/or get image information in the form of a color value per pixel, the color value comprising a red value, a blue value and a green value.

Block 12: Divide the image into blocks, each block comprising a group of pixels.

Block 13: Have all pixels been checked and/or read ? If yes, goto block 21, if no, goto block 14.

Block 14: Obtain the color value comprising the red value, blue value and green value of a pixel, if not already available from block 11.

Block 15: Detect whether the color value fulfils one or more color conditions defined by one or more threshold values. If yes, goto block 16, if no, goto block 13.

Block 16: Detect whether there are neighboring pixels that have fulfilled the one or more color conditions. If yes, goto block 17, if no, goto block 13.

Block 17: Establish a number of pixels that have fulfilled the one or more color conditions.

Block 18: Detect whether the color value (of the number of pixels that has fulfilled the one or more color conditions of block 17) fulfils one or more edge conditions. If yes, goto block 19, if no, goto block 13.

Block 19: Establish a number of pixels that have fulfilled the one or more edge conditions.

Block 21: Establish a function of the number of pixels that have fulfilled the one or more edge conditions and the number of pixels that have fulfilled the one or more color conditions.

Block 22: Detect whether this function fulfils one or more ratio conditions. If yes, goto block 23, if no, goto block 24.

Block 23: In response to a confirming ratio condition detection result, generate a block content detection signal.

Block 24: In response to a non-confirming ratio condition detection result, do not generate a block content detection signal or generate a block content non-detection signal.

Block 31: Have all blocks been checked ? If yes, goto block 32, if no, goto block 21.

Block 32: Establish, for a block for which a confirming block content detection signal has been generated, a number of neighboring blocks for which confirming block content detection signals have been generated, and establish, for the block and the neighboring blocks for which confirming block content detection signals have been generated, a number of pixels that have fulfilled the one or more edge conditions and a number of pixels that have fulfilled the one or more color conditions.

Block 33: Detect whether a function of the number of neighboring blocks for which confirming block content detection signals have been generated fulfils one or more block neighbor conditions, and detect whether a function of the number of pixels that have fulfilled the one or more edge conditions and the number of pixels that have fulfilled the one or more color conditions fulfils one or more further ratio conditions. If yes, goto block 34, if no, goto block 35.

Block 34: In response to a confirming block neighbor condition detection result and a confirming further ratio condition detection result, generate an image content detection signal.

Block 35: In response to a non-confirming block neighbor condition detection result and a non-confirming further ratio condition detection result, do not generate an image content detection signal or generate an image content non-detection signal.

Block 36: Have all blocks been checked ? If yes, goto block 37, if no, goto block 32.

Block 37: End.

At block 11, the image information of the image is converted into a color value per pixel and/or the image information in the form of a color value per pixel is got. The color value may comprise a red value, a blue value and a green value, each defined by a number of bits, without excluding other and/or further options. In case of a value being defined by eight bits, the value may have a size from 0 to 255.

At block 12, a step of dividing the image into blocks is performed, and the image is divided into blocks, for example fifteen rows and fifteen columns of blocks. The image may for example have a resolution of 1024×768 pixels. Larger resolutions may be scaled down. This all without excluding other and/or further options.

At block 15, a step of, for each pixel of a group of pixels, detecting whether the at least one color value fulfils at least one color condition defined by at least one threshold value, is performed. To detect for example a green content such as greeneries like grass, leaves of a tree, and bushes, the following color conditions and threshold values might be used: (((green-value>red-value)∥((green-value+20) && (red-value>85 && green-value>85 && blue-value<50))) && ((green-value>1.2*blue-value)) && (green-value>50 && green-value<165) && (red-value<150 && blue-value<100)). Other color conditions and threshold values are not to be excluded. The term “&&” defines for example AND and the term “∥” defines for example OR.

At block 16, a step (16-1) of, for each pixel from the group of pixels that has fulfilled the at least one color condition, detecting whether there are neighboring pixels that have fulfilled the at least one color condition, is performed, and a step (16-2) of detecting whether a function of a number of neighboring pixels that have fulfilled the at least one color condition fulfils at least one pixel neighbor condition, is performed. This is for example done by checking whether the pixel, that has fulfilled the color condition, has for example minimal two pixels earlier in the same row that also have fulfilled the color condition.

In the flow chart shown in the FIG. 1, for one pixel a color condition is checked, then a pixel neighbor condition is checked, then an edge condition is checked (as discussed below), then this all is repeated for a next pixel for example in a same row and a next column, etc. As a result, the pixel neighbor condition can only be fulfilled with respect to pixels checked earlier. Alternatively, but not shown, for all pixels in a block one after the other a color condition is checked, then for all pixels in the block one after the other a pixel neighbor condition is checked etc. In this case, it is possible to extend the pixel neighbor condition to for example one or two or three further pixels left from and/or right from and/or above and/or below the pixel.

At block 18, a step of, for each pixel from the group of pixels that has fulfilled the at least one color condition of block 17, detecting whether this pixel fulfils at least one edge condition, is performed. Each pixel has a fixed location in the image, and this fixed location may be an edge of the image or the block or the group of pixels or a region, or not. In combination with block 16, the step of detecting whether the pixel fulfils at least one edge condition will need to be performed for each pixel from the group of pixels that has fulfilled the at least one color condition as well as that has neighboring pixels for which the function of the number of these neighboring pixels has fulfilled the at least one pixel neighbor condition.

At block 22, a step of detecting whether a function of a number of pixels that have fulfilled the at least one edge condition and a number of pixels that have fulfilled the at least one color condition fulfils at least one ratio condition, is performed. This is for example done by comparing for example a ratio of the number of pixels that have fulfilled the edge condition and the number of pixels that have fulfilled the color condition with a ratio value.

At block 32, a step of, for a block for which a confirming block content detection signal has been generated, detecting whether there are neighboring blocks for which confirming block content detection signals have been generated, is performed. Further, for example, for the block and the neighboring blocks for which confirming block content detection signals have been generated, a number of pixels that have fulfilled the one or more edge conditions and a number of pixels that have fulfilled the one or more color conditions are established.

At block 33, a step (33-1) of detecting whether a function of a number of neighboring blocks for which confirming block content detection signals have been generated fulfils at least one block neighbor condition, is performed, and a step (33-2) of, for the block and the neighboring blocks for which confirming block content detection signals have been generated, detecting whether a function of a number of pixels that have fulfilled the at least one edge condition and a number of pixels that have fulfilled the at least one color condition fulfils at least one further ratio condition, is performed. This is for example done by comparing for example a ratio of the number of pixels that have fulfilled the at least one edge condition and the number of pixels that have fulfilled the at least one color condition with a further ratio value.

So, firstly decisions are taken based on pixel color properties (color conditions) and smoothness measurements (edge conditions and ratio conditions). Secondly, block level and global decisions are taken (block neighbor conditions and further ratio conditions). If for example in a block a green region measured in numbers of pixels is larger than a first percentage (such as for example 16%) of a block size also measured in numbers of pixels, and if a number of edgy pixels is larger than a second percentage (such as for example 6%) of a number of green pixels, the block is marked as a green block.

When a block has been marked as a green block, its neighbor blocks are considered. If for example in a row or a column a third percentage (such as for example 60%) of the blocks is considered to be green blocks, and if a total number of edgy pixels in this row or this column is larger than a fourth percentage (such as for example 12%) of a total number of green pixels in this row or this column, the (region of) the image is considered to comprise greeneries.

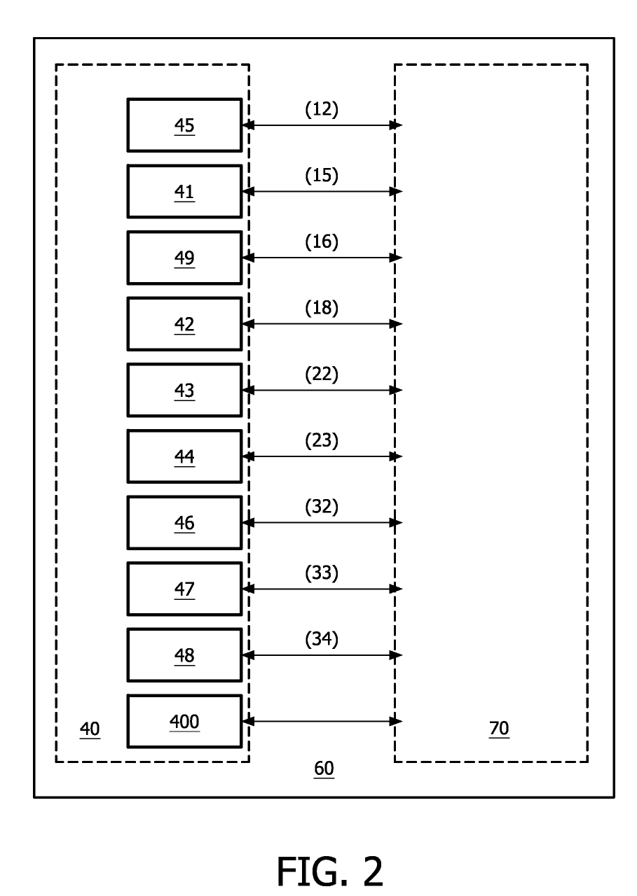

In the FIG. 2, a block diagram of a system 60 comprising a processor 40 and a memory 70 is shown. Such a system is for example a processor-memory system. The processor 40 comprises detection means 41 for performing the first step 15, detection means 42 for performing the second step 18, detection means 43 for performing the third step 22, generation means 44 for performing the fourth step 23, division means 45 for performing the fifth step 12, detection means 46 for performing the sixth step 32, detection means 47 for performing the seventh and eighth steps 33-1 and 33-2 together indicated by a reference sign 33, generation means 48 for performing the ninth step 34, and detection means 49 for performing the tenth and eleventh steps 16-1 and 16-2 together indicated by a reference sign 16.

Thereto, control means 400 control the means 41-49 and control the memory 70. The means 41-49 and 400 are for example individually coupled to the memory 70 as shown, or are together coupled to the memory 70 via coupling means not shown and controlled by the control means 400. Several detection means might be integrated into single detection means, and several generation means might be integrated into single generation means. Detection means are for example realized through a comparator or through a calculator. Generation means are for example realized through an interface or a signal provider or form part of an output of other means. Division means are for example realized through an allocator (that for example allocates a code for indicating the block to a color value per pixel) or through a replacer (that for example replaces a color value per pixel by a longer value for also indicating the block).

The steps are numbered in the FIG. 2 between brackets located above couplings between the means 41-49 and the memory 70 to indicate that usually for performing steps the means 41-49 will consult the memory 70 and/or load information from the memory 70 and/or process this information and/or write new information into the memory 70 etc. and all under control by the control means 400.

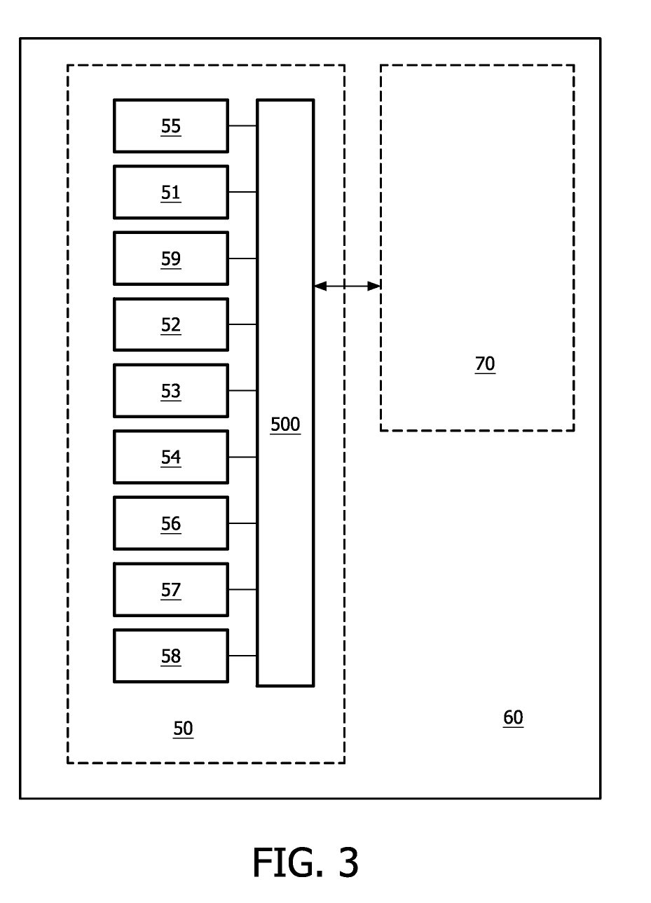

In the FIG. 3 a block diagram of a system 60 comprising a device 50 and a memory 70 is shown. The device 50 comprises a detector 51 for performing the first step 15, a detector 52 for performing the second step 18, a detector 53 for performing the third step 22, a generator 54 for performing the fourth step 23, a divider 55 for performing the fifth step 12, a detector 56 for performing the sixth step 32, a detector 57 for performing the seventh and eighth steps 33-1 and 33-2, a generator 58 for performing the ninth step 34, and a detector 59 for performing the tenth and eleventh steps 16-1 and 16-2.

Thereto, a controller 500 controls the units 51-59 and controls the memory 70. The units 51-59 are individually coupled to the controller 500 which is further coupled to the memory 70 as shown, or a separate coupler not shown and controlled by the controller 500 might be used for coupling the units 51-59 and the controller 500 and the memory 70. Several detectors might be integrated into a single detector, and several generators might be integrated into a single generator. Detectors are for example realized through a comparator or through a calculator. Generators are for example realized through an interface or a signal provider or form part of an output of other units. Dividers are for example realized through an allocator (that for example allocates a code for indicating the block to a color value per pixel) or through a replacer (that for example replaces a color value per pixel by a longer value for also indicating the block).

Usually for performing steps the units 51-59 will consult the memory 70 and/or load information from the memory 70 and/or process this information and/or write new information into the memory 70 etc. and all under control by the controller 500.

Summarizing, methods for image content detection check (15) color values of pixels via color conditions and check (18) pixels via edge conditions and check (22) functions of numbers of edge conditioned pixels and numbers of color conditioned pixels via ratio conditions and generate (23), in response to ratio condition detection results, block content detection signals. These methods perform well for green content (greeneries like grass, leaves of trees, bushes) and blue content (water like river water, sea water) and are used for content based classifications and automatic selections of images. The methods may be repeated (12) for different blocks of an image, and may then check (32), for a block, neighboring blocks and may check (33-1) functions of numbers of neighboring blocks via block neighbor conditions and may check (33-2) functions of numbers of edge conditioned pixels and numbers of color conditioned pixels via further ratio conditions and may generate (34), in response to block neighbor condition detection results and further ratio condition detection results, image content detection signals.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for detecting a content of at least a part of an image comprising pixels, each pixel being defined by at least one color value, which method comprises:
a first step (15) of, for each pixel of a group of pixels, detecting whether the at least one color value fulfils at least one color condition defined by at least one threshold value,
a second step (18) of, for each pixel from the group of pixels that has fulfilled the at least one color condition, detecting whether this pixel fulfils at least one edge condition,
a third step (22) of detecting whether a function of a number of pixels that have fulfilled the at least one edge condition and a number of pixels that have fulfilled the at least one color condition fulfils at least one ratio condition, and
a fourth step (23) of, in response to a ratio condition detection result, generating a block content detection signal.

2. A method as claimed in claim 1, wherein
the first step (15) comprises a sub-step of, in response to a color condition detection result, generating a color condition signal,
the second step (18) comprises a sub-step of, in response to an edge condition detection result, generating an edge condition signal, and
the third step (22) comprises a sub-step of, in response to a ratio condition detection result, generating a ratio condition signal.

3. A method as claimed in claim 1, further comprising:
a fifth step (12) of dividing the image into blocks, a first block comprising a first group of pixels, and a second block comprising a second group of pixels, the group of pixels for a first set of first to fourth steps comprising the first group of pixels, and the group of pixels for a second set of first to fourth steps comprising the second group of pixels.

4. A method as claimed in claim 3, further comprising:
a sixth step (32) of, for a block for which a confirming block content detection signal has been generated, detecting whether there are neighboring blocks for which confirming block content detection signals have been generated,
a seventh step (33-1) of detecting whether a function of a number of neighboring blocks for which confirming block content detection signals have been generated fulfils at least one block neighbor condition,
an eighth step (33-2) of, for the block and the neighboring blocks for which confirming block content detection signals have been generated, detecting whether a function of a number of pixels that have fulfilled the at least one edge condition and a number of pixels that have fulfilled the at least one color condition fulfils at least one further ratio condition, and
a ninth step (34) of, in response to a block neighbor condition detection result and a further ratio condition detection result, generating an image content detection signal.

5. A method as claimed in claim 1, further comprising:
a tenth step (16-1) of, for each pixel from the group of pixels that has fulfilled the at least one color condition, detecting whether there are neighboring pixels that have fulfilled the at least one color condition, and
an eleventh step (16-2) of detecting whether a function of a number of neighboring pixels that have fulfilled the at least one color condition fulfils at least one pixel neighbor condition, the second step of detecting whether the pixel fulfils at least one edge condition being performed for each pixel from the group of pixels that has fulfilled the at least one color condition as well as that has neighboring pixels for which the function of the number of these neighboring pixels has fulfilled the at least one pixel neighbor condition.

6. A computer program product for performing the steps of the method as claimed in claim 1.

7. A medium for storing and comprising the computer program product as claimed in claim 6.

8. A processor (40) for performing the steps of the method as claimed in claim 1, which processor (40) comprises:
first detection means (41) for performing the first step (15),
second detection means (42) for performing the second step (18),
third detection means (43) for performing the third step (22), and
generation means (44) for performing the fourth step (23).

9. A device (50) for detecting a content of at least a part of an image comprising pixels, each pixel being defined by at least one color value, which device (50) comprises:
a first detector (51) for, for each pixel of a group of pixels, detecting whether the at least one color value fulfils at least one color condition defined by at least one threshold value,
a second detector (52) for, for each pixel from the group of pixels that has fulfilled the at least one color condition, detecting whether this pixel fulfils at least one edge condition,
a third detector (53) for detecting whether a function of a number of pixels that have fulfilled the at least one edge condition and a number of pixels that have fulfilled the at least one color condition fulfils at least one ratio condition, and
a generator (54) for, in response to a ratio condition detection result, generating a block content detection signal.

10. A system (60) comprising the device (50) as claimed in claim 9 and further comprising a memory (70) for storing color values of pixels of images.
